(19) United States
(12) Patent Application Publication
(10) Pub. No.: US 2010/0316259 A1
(43) Pub. Date: Dec. 16, 2010

(54) Using a moving imaging system to monitor anatomical position as a function of time

(76) Inventors: Wu Liu, Mountain View, CA (US); Rodney D. Wiersma, Chicago, IL (US); Nadeem Raiz, Palo Alto, CA (US); Jing Wang, San Carlos, CA (US); Lei Xing, Palo Alto, CA (US)

Correspondence Address: LUMEN PATENT FIRM, 350 Cambridge Avenue, Suite 100, PALO ALTO, CA, 94306, US

(21) Appl. No.: 12/802,952

(22) Filed: Jun. 16, 2010

Related U.S. Application Data
(60) Provisional application No. 61/268,883, filed on Jun. 16, 2009.

(51) Int. Cl. G06K 9/00

(52) U.S. Cl. 382/107; 378/62; 378/65

(57) ABSTRACT

Real-time 3D tracking of anatomical positions during radiation therapy uses acquired image data from an MV treatment beam as it is rotated around the patient during arc radiotherapy treatment. The acquired image data and associated angular positions are computationally combined during the arc radiotherapy treatment to estimate in real time 3D positions of anatomical features of the patient, e.g., combining present image data and prior image data at earlier times. Supplementary image data from a kV imaging system may be acquired on an as-needed basis if MV position estimates indicate movement exceeding a predetermined threshold, and the supplementary kV image data combined with the acquired MV image data to improve an accuracy of the estimated 3D positions.

### CROSS-REFERENCE TO RELATED APPLICATIONS

This application claims priority from U.S. Provisional Patent Application 61/268,883 filed Jun. 16, 2009, which is incorporated herein by reference.

### FIELD OF THE INVENTION

This invention relates generally to methods and systems for medical imaging. More specifically, it relates to improved techniques for determining and tracking anatomical positions as a function of time.

### BACKGROUND OF THE INVENTION

A goal of x-ray radiotherapy systems is to precisely deliver MV radiation beam to desired locations while minimizing exposure to undesired locations. Movement of internal organs (e.g., prostate) during treatment poses a challenge to this goal. A necessary step in combating the adverse effects of intrafraction prostate motion is real-time monitoring of the target position. Several methods for obtaining the data in real time have been proposed. Prostate tracking using electromagnetic transponders has recently been developed. However, due to its large physical size, the transponder produces severe magnetic resonance imaging artifacts and hinders magnetic resonance-based post-treatment assessments. Currently, x-ray imaging with implanted metallic fiducial markers remains the most reliable method to monitor organ motion.

With increased interest in hypofractionated treatment and the use of multiple arcs, which protract the delivery, the need for intrafraction motion monitoring during arc therapy will be increased further. Moreover, to document and verify the target position during arc therapy delivery, real-time monitoring of the prostate position will be important.

Research in radiotherapy has shown that the prostate target moves during the radiotherapy dose delivery process and that the motion is generally unpredictable and can be greater than 1 cm in some cases. Real-time monitoring of implanted fiducial markers using cine-megavoltage (MV) and onboard kilovoltage (kV) beams has been proposed for real-time monitoring of tumor target motion. Although continuous fluoroscopic kV and cine-MV imaging is capable of providing real-time information of the prostate position, with spatial accuracy less than 1 mm, continuous or periodic use of such kV imaging to monitor the prostate motion results in unwanted additional radiation dose to the patient. A reliable reduction of kV beam use would be highly desirable to reduce the patient imaging dose, but no current techniques exist to reduce or eliminate the kV dose while still providing real-time 3D tracking.

### SUMMARY OF THE INVENTION

While real-time 3D tracking of human anatomy using two or more kV x-ray sources is well investigated, techniques of the present invention use the actual radiation treatment beam information (captured using a detector), together with gantry rotation, for spatial and temporal tracking of patient anatomy. Compared to other fluoroscopic tracking systems which require the use of two or more X-ray imaging systems, embodiments of the invention only require the use of one x-ray imaging system for motion monitoring for great majority of the time. When using the MV treatment beam, embodiments of the invention have the potential for allowing full anatomical motion monitoring with nearly zero additional imaging dose to the patient.

Real-time monitoring of tumor motion during the course of radiotherapy delivery represents a critical step to alleviate the adverse effect of intra-fractional organ motion and to ensure adequate doses to target volumes and safe doses to normal tissues. Accordingly, embodiments of the invention provide an effective means of tracking 3D anatomy of a patient by taking advantage of the inherent mechanism of gantry rotation together with x-ray imaging during radiotherapy.

In one aspect, the invention provides a method for using a moving imaging system for geometric tracking of anatomy as a function of time. Present image data is used together with prior image data acquired at different spatial positions of the imager to determine and monitor the geometric position of a 3D object.

In comparison to other techniques, which require two or more x-ray sources for 4D (3D+time) tracking, this technique can accomplish full 4D tracking with only the MV treatment beam, leading to zero imaging dose cost to the patient. This approach is thus ideally suited to arc-based radiotherapy modalities such as Rapid Arc and VMAT, where the gantry is continually rotated during treatment.

Embodiments of the invention may also enhance the performance of existing 4D organ motion tracking techniques as MV-kV 4D tracking. Inclusion of gantry rotation, together with the combined MV and kV imaging, may allow for multiple levels of target position verification leading to increased tracking precision and robustness. Additionally, embodiments of the invention allow for patient imaging dose sparing by turning off of the kV beam whenever the MV imager can solely accomplish motion monitoring during gantry rotation.

Conventional prostate motion monitoring techniques seek to accurately localize the markers using continuous or periodic fluoroscopic kV imaging. The inventors have surprisingly discovered that it is neither necessary nor dose efficient to use continuous or periodic fluoroscopic kV imaging, together with the MV beam, because the prostate motion does not occur continuously. Thus, according to the principles of one embodiment of the present invention, a kV imaging is not activated unless a warning signal from a failure detection device is triggered, e.g., only when the motion is greater than a specific threshold. Compared with other continuous kV-tracking modalities, which have generally required frequent use of kV beams, this technique offers sufficiently accurate target monitoring with a reduced imaging dose to the patient because the treatment is delivered in an arc. The scheme uses the treatment beam for “failure detection” and individualizes the use of kV imaging to each treatment session. On confirmation of an overthreshold displacement, a number of interventional strategies can be implemented to compensate for the motion, e.g., moving the couch or shifting the subsequent multileaf collimator (MLC) apertures. The approach is also suitable for monitoring other organs with slow and unpredictable motion.

In one aspect, a novel prostate motion tracking technique using cine-MV and as-needed kV imaging is provided. A distinct feature of the method is that continuous accurate position information is not actively pursued during the delivery process. Instead, the technique focuses its attention to detecting any motion potentially greater than a preset threshold (i.e., “failure” detection) by taking advantage of the continuous gantry rotation during arc delivery. If significant fiducial motion occurs, kV imaging is triggered to accurately locate the current position of the prostate through triangulation with the MV data. This technique is capable of reliably tracking the prostate position during the arc therapy delivery process. It is able to provide high confidence about prostate displacement, without the unwanted overhead of continuous or periodic kV imaging. The technique can be readily implemented on linear accelerators equipped with electronic portal imaging device and onboard kV imaging devices.

A computational technique capable of providing current anatomy by combined use of recent imaging data and imaging data at earlier time(s) and their derivatives provides accurate monitoring of the geometric position of a 3D object.

In addition, a computational method has been devised that allows continuous motion monitoring during MV beam-defining aperture blocks of the target, or other MV beam interruptions, that could otherwise lead to loss of target information necessary for 3D localization. Using both present and prior positions of the target in gathered MV and kV images, a correlation model can be quickly constructed such that the MV and kV imagers are intertwined in a robust manner, where accurate estimation of the 3D position of the target can still be computed provided that at least one imager (MV or kV) is available to provide 2D target information.

Additionally, an inverse treatment planning strategy to spare one or more fiducials from MLC blocking during an arc delivery process may be used.

The techniques provide for 3D geometric tracking of organs by taking advantage of the inherent mechanism of radiotherapy gantry rotation together with the x-ray based imaging. The advantages of this technology include the following:
Imaging system motion (i.e., gantry rotation) can be exploited to allow anatomical motion monitoring.
Imaging radiation exposure to the patient is dramatically reduced or eliminated.
No significant hardware modification on existing treatment machines is needed.
Current acquired x-ray images are used together with prior images captured at earlier times and their derivatives, such as the spatial and temporal correlation of the data or digital tomosynthesis, for calculating the location of a target.
Motion monitoring during MV beam-defining aperture blocks of the target is possible.
A treatment planning method to avoid MLC blockage of the implanted fiducial(s) can be used.

In some embodiments, a moving kV x-ray imaging system source may be used to accomplish anatomical motion monitoring or to aid the MV based tracking. Specific MV segment(s) may be added to the treatment beam to aide the MV imaging. A dynamic update digital tomosynthesis technique may be used to reconstruct nearly real-time 3D structure information for feature tracking or fiducial tracking with added information. The technique may also be extended to fixed-gantry radiotherapy where the prior information comes from images acquired at previous segments or during gantry rotation between segments.

In one aspect, a method is provided for real-time 3D tracking of anatomical position during radiation therapy. The method includes acquiring image data using an MV treatment beam delivered to and rotated around a patient during an arc radiotherapy treatment. The acquired image data and associated angular positions are computationally combined during the arc radiotherapy treatment to estimate in real time 3D positions in time of an anatomical feature of the patient or implanted fiducial marker. When possible and necessary, tomosynthetic images are reconstructed from the projection images of the MV treatment beam during the arc radiotherapy treatment. Computationally combining the acquired image data may include combining present image data and prior image data at earlier times. The method may also include determining a motion of the anatomical feature or fiducial marker from the estimated 3D positions in time. During the arc radiotherapy treatment, the method may include acquiring supplementary image data from an imaging system (e.g., a kV imaging system), and computationally combining the acquired supplementary image data with the acquired image data to improve an accuracy of the estimated 3D positions. Preferably, acquiring supplementary image data from the imaging system is performed only when an estimated motion of the anatomical feature or implanted fiducial marker exceeds a predetermined threshold or abnormality level.

### BRIEF DESCRIPTION OF THE DRAWINGS

FIG. 1 is a schematic diagram of an apparatus for implementing real-time 3D tracking of anatomical position where no kV imager is used together with the MV treatment beam, according to an embodiment of the invention.

FIG. 2 is a schematic diagram of an apparatus for implementing real-time 3D tracking of anatomical position where one kV imager is used together with the MV treatment beam, according to an embodiment of the invention.

FIGS. 3A and 3B are schematic illustrations of geometrical aspects of a technique for real-time 3D tracking of anatomical position, according to an embodiment of the invention.

FIG. 4 is a flowchart of a technique for real-time 3D tracking of anatomical position, according to an embodiment of the invention.

FIGS. 5A and 5B are histograms showing performance of a conventional technique and a technique according to an embodiment of the present invention, respectively.

### DETAILED DESCRIPTION

In a preferred embodiment of the invention, techniques are provided for real-time position monitoring of anatomical position (e.g., prostate) through novel use of cine-megavoltage (MV) imaging, optionally combined with as-needed kilovoltage (kV) imaging. The techniques are especially valuable in the context of modern arc radiotherapy.

A commercially available radiotherapy system (e.g., Trilogy™, Varian Medical System, Palo Alto, Calif.) may be used to practice one embodiment of the invention. Successive MV treatment beam images were acquired during an arc radiotherapy delivery. Using the present and prior acquired images together with their known angular separation, a computational method was used to determine 3D fiducial locations as a function of time. The fiducial position information was updated at the rate of MV imaging frame rate. Each frame can be used in conjunction with the previous images to reconstruct the 3D fiducial position. From phantom studies the geometric accuracy of the system was found to be on the order of ±1 mm or better in all three spatial dimensions for slow moving targets. If an irregular fast motion happens, the technique can detect the change. If the change is larger than a preset threshold, the technique will report a “failure” for further handling.

The task of monitoring the intrafraction prostate motion may be divided into two main steps for rotational deliveries: 1) detect potential target motion beyond a predefined threshold using MV images from different viewing angles by taking advantage of gantry rotation during arc therapy and 2) verify the displacement and determine whether intervention is needed using fiducial/tumor position information acquired from combined MV-kV imaging (by turning on the kV imager). A Varian Trilogy linear accelerator with an onboard kV imager may be used to examine selected typical trajectories using a four-dimensional motion phantom.

By focusing the attention on detecting predefined abnormal motion (i.e., “failure” detection) and using the inherent mechanism of gantry rotation during arc radiotherapy, the current approach provides high confidence regarding the prostate position in real time without the unwanted overhead of continuous or periodic kV imaging. Compared with other fluoroscopy-based tracking techniques, kV use was significantly reduced to an average of less than 15 times per arc delivery.

If the therapeutic dose is delivered in an arc, the fiducial marker/tumor positions can be stereoscopically estimated by taking advantage of the inherent mechanism of continuous gantry rotation. This estimation is done with the analysis of the “free” MV images acquired from different angles and forms a rational basis to minimize or eliminate use of kV imaging for position determination. During arc therapy, the MV projections corresponding to different points in time (gantry angles) do not provide the full three-dimensional (3D) coordinates of the fiducial markers. However, with an adequately established baseline position of the prostate at the beginning of treatment, the MV projection data can be used to determine whether the prostate has moved from the baseline position and whether the displacement is greater than a preset threshold (e.g., ˜3 mm). If the threshold is exceeded, the estimated displacement of the prostate target using the MV projections at different points is then used to direct the use of orthogonal kV imaging. If a potential overthreshold motion is detected by MV imaging, kV imaging can be used (for a single shot or a certain period) to accurately locate the 3D prostate position using simultaneous MV-kV imaging for possible intervention. The techniques of the to present invention provide such an MV data processing method and optimal kV imaging protocol for arc therapy. The scheme of using the kV imager on an “as needed” basis has the potential to significantly improve the current “one-protocol-for-all-treatment” approach of prostate image-guided radiotherapy.

Prior methods have been proposed to combine kV imaging with cine-MV imaging to monitor implanted gold seeds during prostate image-guided radiotherapy. These include continuous kV imaging and periodic kV according to previously established prostate motion statistics. These two methods are in the category of “one-protocol-for-all-treatment”. The present technique, in contrast, does not require kV imaging and optionally uses kV imaging only if the estimated prostate displacement or speed from the up-to-date MV projections has exceeded a threshold. Because of the random and relatively infrequent nature of prostate motion, as will be seen in the following sections, the third approach can outperform the first two by reducing or eliminating kV use while maintaining a high level of marker tracking accuracy compared with continuous kV imaging.

The present description of the preferred embodiments focus on tracking prostate motion using cine-MV and as-needed kV projections. Those skilled in the art will recognize that the prostate is just an illustrative example of an anatomical feature that can be tracked, and that the techniques of the invention are not limited to prostate tracking.

A central idea of the technique is to estimate the fiducial displacement using MV-only data by taking advantage of the continuous gantry rotation during arc therapy, using the kV imager only upon the detection of possible abnormal motion. Therefore, we divided the task of monitoring intrafraction prostate motion into two separate, but related, steps: first, to detect any abnormal target motion through continuously updated MV images; and, second, to confirm and accurately locate the fiducial markers using the kV imager only if a potential abnormal motion were detected. The accurate position information is then used to guide additional intervention.

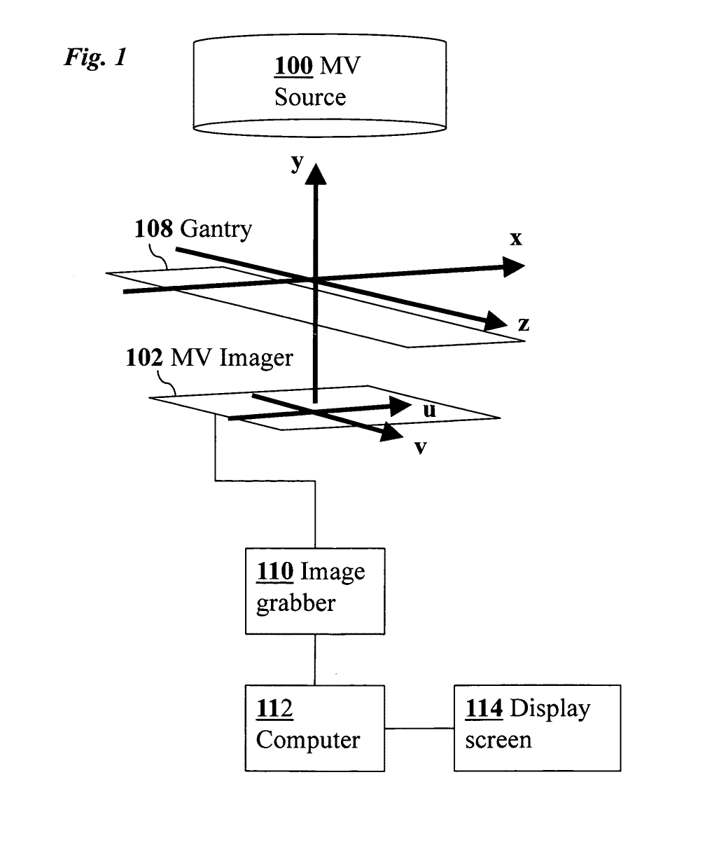

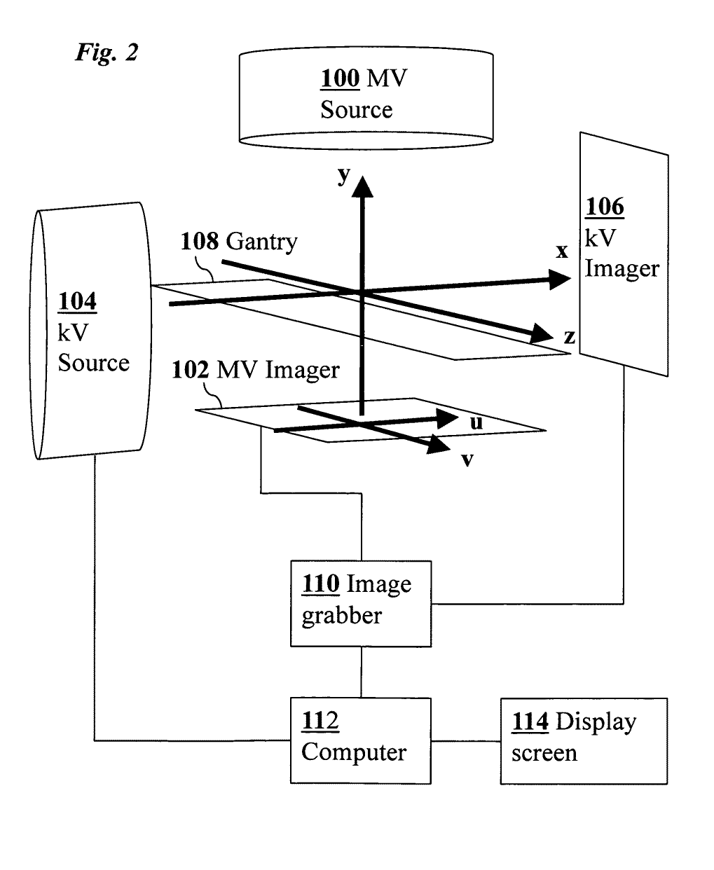

An imaging system which may be used to implement the techniques of the present invention is shown in the schematic diagram of FIG. 1. An MV source 100 emits a treatment x-ray beam that is detected by MV imager 102. A couch 108 upon which a patient rests is positioned in the path of the MV beam. The MV source 100 and MV imager 102 rotate relative to couch 108 during the arc radiotherapy treatment. The MV imager 102 is connected to an image grabber 110 which acquires MV image data during the treatment. Computer 112 combines the acquired MV image data and associated angular positions of the beam relative to the patient to estimate in real time the 3D positions of the prostate or other anatomical feature of the patient. The images, position information, or other data can be displayed in real time on display screen 114. The real time position is computed from the acquired MV image data by combining present MV image data and prior MV image data at earlier times. The motion of the anatomical feature may also be determined from the estimated 3D positions in time. In another embodiment, during the arc radiotherapy treatment, supplementary image data from a kV imaging system may also be acquired at specified times. The acquired supplementary kV image data may then be combined by the computer with the acquired MV image data to improve an accuracy of the estimated 3D positions. Preferably, this supplementary kV image data is acquired from a kV imaging system only when an estimated motion of the anatomical feature exceeds a predetermined threshold. FIG. 2 illustrates an imaging system which may be used to implement this technique. Just like the system in FIG. 1, it has an MV source 100, couch 108, MV imager 102, image grabber 110, computer 112, and display screen 114. In addition, it also has a kV source 104 and kV imager 106, both of which may rotate with MV source and MV imager 102 relative to gantry 108 during arc radiotherapy treatment. The image grabber acquires both kV image data and MV image data. Computer 112 controls kV source 104 only when an estimated motion of the anatomical feature exceeds a predetermined threshold.

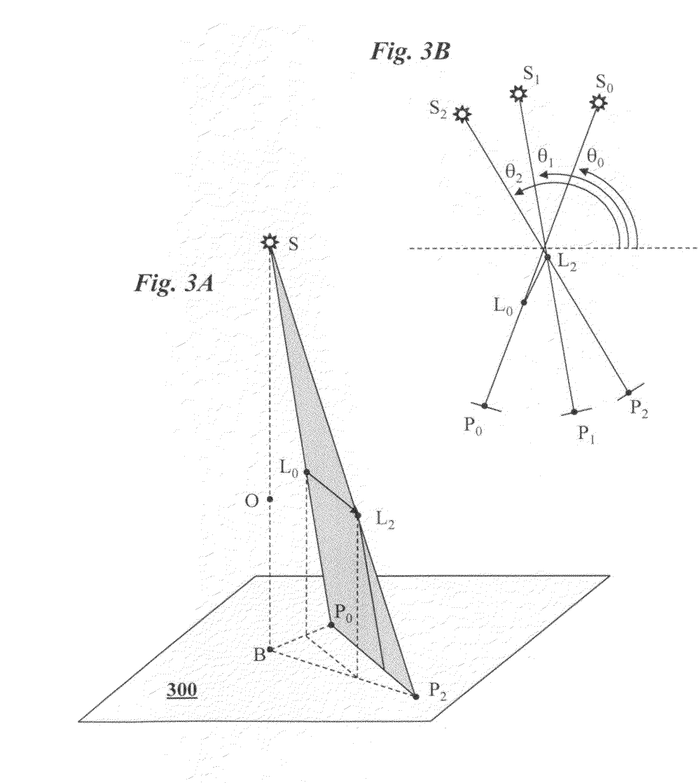

An illustration of the MV imaging projection geometry is shown in FIGS. 3A and 3B. As shown in FIG. 3A, at a given gantry angle, the marker positioned at L₂ illuminated by the treatment beam from x-ray source S₂ results in the projection point P₂ on the MV electronic portal imaging device plane 300. A previous position L₀ of the marker results in a different projection point P₀. To determine or estimate the 3D marker position, (x, y, z), a triangulation of two projections may be used. One MV image provides two known parameters; therefore, at least one more parameter may be used to solve for all three unknown coordinates. This additional parameter can be obtained from various sources such as a kV image, another MV image acquired at a different gantry angle, or a prior treatment setup scan.

FIG. 3B illustrates the projection geometry used for displacement estimation using sequential MV projections at different times and angles. Let a prior fiducial position be L₀, determined for example by simultaneous MV-kV imaging at time t₀. At later times t₁ and t₂, only cine-MV images are acquired. This later data is then combined with the prior data to estimate the fiducial displacement from checkpoint L₀ to displaced position L₂. Let S₀, S₁, and S₂ represent the X-ray source positions at known times t₀, t₁, t₂, and known respective gantry rotation angles θ₀, θ₁, θ₂. The corresponding projections of the fiducial on the imager are points P₀, P₁, and P₂, respectively. The task is to estimate from its projection position P₂ at time t₂ and other system information whether the fiducial marker has moved from L₀ by more than a predefined threshold distance. To locate the position L₂ of the marker at t₂ uses data in addition to the projection P₂. During gantry rotation, cine-MV images are acquired from a wide variety of angular views. Thus, the projection P₁ acquired at an earlier time t₁ may be used as a second projection to be combined with the other available data for estimation of the extent of prostate displacement from L₀. Because t₁ and t₂ correspond to two different points, the triangulation of the projections P₁ and P₂ will not be meaningful unless the marker motion is insignificant during the sampling interval between t₁ and t₂. As long as this interval is sufficiently small (i.e., less than the average time for the prostate to move significantly, 2 mm), the triangulation should provide a reasonable estimate of the marker position. However, the angular separation between two MV images should not be too small. Otherwise, the reconstruction would be too susceptible to image noise and other small errors in the projection data. Theoretical and experimental studies by the inventors indicate that an ˜10° separation is a balanced choice for prostate motion monitoring. It usually takes 2-3 seconds for the gantry to rotate 10° during arc delivery. The distance from L₀ to L₂ obtained using projections P₁ and P₂ with 10° separation provides a reasonable estimate of the marker displacement with respect to the checkpoint L₀. If the separation from L₀ to L₂ is greater than a predetermined threshold, e.g., 3 mm, then kV imaging is triggered to more accurately locate the fiducial marker. If the MV-kV image confirms the overthreshold movement, then the checkpoint is updated, i.e., the target is repositioned or the MLC is shifted. With an objective accuracy of image guidance less than 3 mm, we set the MV-kV action level for checkpoint update at 2.5 mm to count for various uncertainties. Using an action level of less than 3 mm enhanced our confidence level in catching overthreshold motion, although at the cost of a slightly increased number of checkpoint repositioning events.

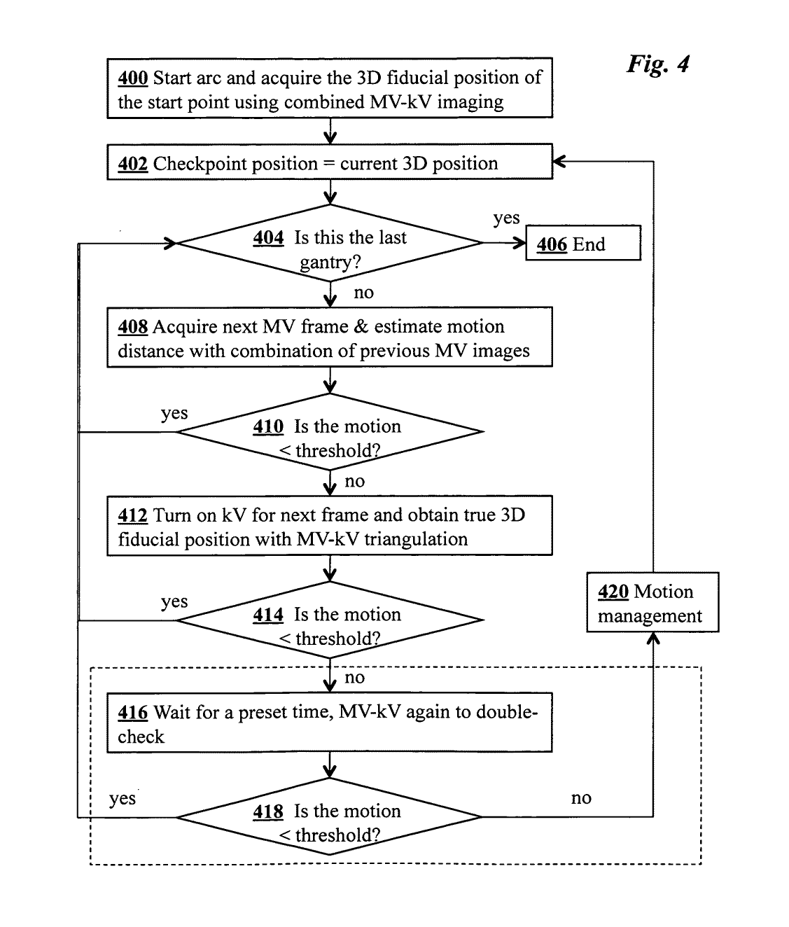

FIG. 4 shows a flowchart of the technique according to an embodiment of the invention. The process begins in step 400 where the fiducial marker position is initialized. Because of the absence of previous knowledge at the beginning of treatment, the kV imager may be turned on once to acquire the first accurate 3D marker position. These data can also come from the patient setup images, provided the elapsed time between the setup and treatment has been sufficiently short. In step 402, the current checkpoint is set to the current 3D marker position. Step 404 then checks to see if the arc radiotherapy treatment is completed, i.e., if the last gantry rotation angle is completed. If so, then the process ends at step 406. Otherwise, step 408 rotates the gantry, acquires the next MV image frame and uses prior checkpoint position and prior MV image data (or fiducial positions estimated therefrom) to estimate the current marker position and its displacement from the checkpoint position. Step 410 checks if the estimated displacement is less than a predetermined threshold for motion. If so, the process goes back to step 404 to the next frame. If not, then step 412 activates the kV imager and obtains 3D fiducial marker position using MV-kV triangulation. Step 414 then checks if the estimated displacement using the additional information from the MV-kV data is less than the predetermined threshold for motion. If so, the process goes back to step 404 to the next frame. If not, then the process delays for a predetermined time interval, and repeats the MV-kV imaging to obtain 3D fiducial marker position again. In step 418 the process again checks if the estimated displacement is less than the predetermined threshold for motion. If so, the process goes back to step 404. If not, then significant motion has been detected, so the system performs motion management in step 420. The process then returns to step 402 where the checkpoint position is set to the current 3D position. Motion management can be done through automatic couch control to reposition the patient to the position at the beginning of the treatment or dynamically shifting the MLC to compensate for the detected prostate motion.

This estimation method is well suited for slow prostate motion in which the displacement is less than about 1 mm/s, representing most typical clinical situations (i.e., 99.5% of the time). In some rare but possible situations, the prostate might move more than a few millimeters each second (e.g., because of passing gas in the rectum).

This estimation technique can be used to reliably detect potential large displacements most of the time. In some embodiment, kV imaging may also be triggered when the projected fiducial motion speed on the MV imager is large, because this indicates that the MV-only localization is not accurate. In the present technique, the kV imager may be activated if the MV pair-derived displacement is greater than 3 mm (regardless of the speed value) or if the MV-estimated displacement is greater than 2 mm and the MV-estimated fiducial two-dimensional projection speed is greater than 1 mm/s.

Because of the more intelligent use of the kV system, this technique significantly reduces the use of the kV beam compared with a continuous or periodic kV-on scheme. In some embodiments, the MV beam alone is sufficient and the kV imager is not part of the system. Moreover, sudden large displacements can be detected more effectively using this technique than using the periodic MV-kV imaging (22.5° interval) method. This is understandable because the cine-MV imaging continuously estimates the marker displacement and triggers kV imaging as needed. In contrast, the periodic MV-kV method acquires marker position information only at fixed points.

Table 1 compares properties of several known methods with those of a technique of the present invention using 536 prostate motion tracks from 17 patients. Three useful evaluation quantities are shown: 1) the percentage of time that the marker displacement exceeded the preset threshold of 3 mm, which quantified the undetected/uncorrected overthreshold displacement; 2) the number of kV-on events; and 3) the number of checkpoints (repositionings) confirmed by simultaneous MV-kV imaging. Of the 536 tracks considered, only 74 had a displacement of greater than 3 mm. This observation highlights the importance of this cine-MV technique. The results imply that continuously or periodically switching the kV system on is unnecessary for most treatment fractions in prostate arc therapy. Compared with no motion monitoring, the data in Table 1 show that the periodic MV-kV scheme reduced the percentage of overthreshold time, leading to improved beam targeting. The targeting performance was improved if kV imaging was used more frequently (kV-on every 22.5° vs. kV-on every)45°. Compared with the periodic (every)22.5° MV-kV method, the technique of the present invention significantly reduced the overthreshold time for a similar amount of average kV use. No track had a percentage of overthreshold time of greater than 2.1%. In contrast, the corresponding value was as great as 25.9% for the periodic (every 22.5°) kV imaging scheme. The total number of checkpoint updates was doubled for the method of the present invention. Together with better timing in the checkpoint updates, this explains why the percentage of overthreshold time was significantly reduced.

TABLE 1
Comparison of different motion monitoring strategies

| | Original | kV on | kV on at 5°, | Technique |
|---|---|---|---|---|
| | motion | at 5°, 45°, | 22.5°, 45°, | of |
| | tracks (no | 90°, 135°, . . . , | 67.5°, . . . , | the present |
| Variable | monitoring) | 315° | 337.5° | invention |
| Mean | 21.4 | 6.0 | 4.0 | 0.4 |
| percentage of | | | | |
| overthreshold | | | | |
| time* (%) | | | | |
| Maximum | 95.6 (86.2) | 36.9 (18.1) | 25.9 (11.7) | 2.1 (1.5) |
| (95th | | | | |
| percentile) | | | | |
| percentage of | | | | |
| overthreshold | | | | |
| time* (%) | | | | |
| Mean kV-on | — | 7 | 15 | 13.4 |
| per track** (n) | | | | |
| Mean | — | 0.16 | 0.23 | 0.49 |
| checkpoint | | | | |
| updates | | | | |
| (repositioning) | | | | |
| per track** (n) | | | | |

*Numbers were obtained from 74 three-dimensional tracks that contained overthreshold motion.
**Numbers were obtained by averaging all 536 three-dimensional tracks.

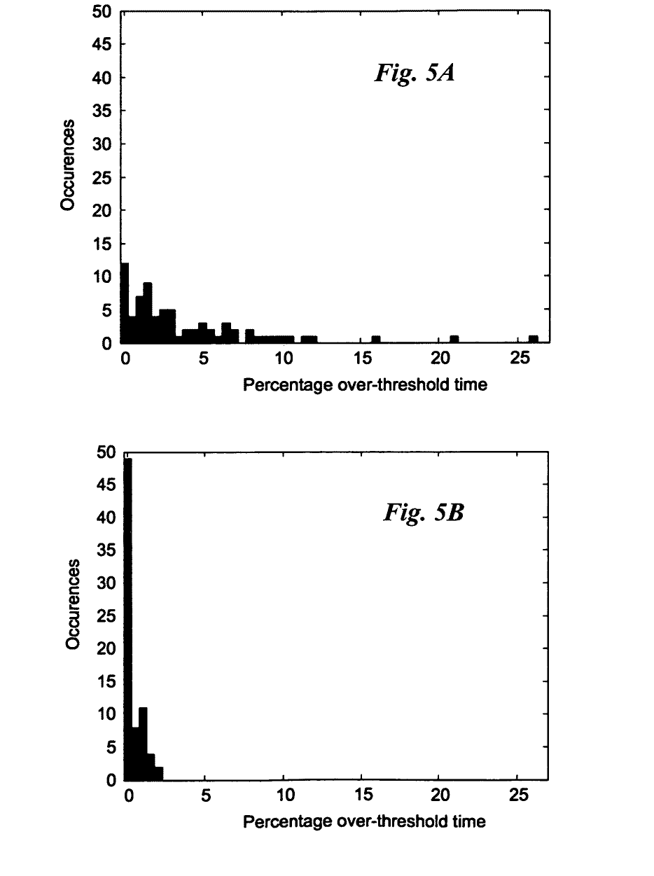

FIGS. 5A and 5B show histograms of the percentage of overthreshold time, a good indicator of the motion monitoring efficiency, for periodic kV imaging and the protocols to techniques of a preferred embodiment of the invention, respectively, for the 74 tracks that contained overthreshold motion. FIG. 5A shows that the periodic kV imaging technique has significant percentages above 2%, while FIG. 5B shows that the technique of the present invention has none above 2%. The few non-zero percentages of overthreshold time of the FIG. 5B is attributed to missed or delayed detection of overthreshold motion resulting from a small, but finite, probability of underestimating the marker displacement. These histograms further demonstrate the advantage of the techniques of the present invention in minimizing the percentage of overthreshold displacement.

The position estimation in the present technique may be done using MV projection pairs of about 10° apart. More sophisticated estimation of fiducial displacement with the optimal use of multiple MV projections at different times and other previous knowledge of prostate motion can also be used. However, we do not anticipate any significant changes when multiple projection data are used for reconstruction.

When an intensity-modulated beam is used for in-line imaging, a potential difficulty is that the fiducial markers might be partially or completely blocked by the MLC leaves at certain angles. Accordingly, the techniques of the present invention may be combined with a fiducial blockage avoidance strategy, such as those used in the context of intensity-modulated radiotherapy. Using such techniques, it is possible to ensure “seeing” at least one of the implanted fiducial markers in any of the intensity-modulated radiotherapy segments for monitoring the fiducials during a step-and-shoot dose delivery by adding to the objective function a hard or soft constraint that characterizes the level of preference for the fiducial marker to be included in the segmented fields. The final dose distributions of three plans (i.e., constraint-free and soft and hard constraints) are very similar, because the fiducial markers are generally placed inside the target volume. The strategy could be implemented for VMAT in a similar fashion. The combined gantry, marker, and MLC motion during VMAT, however, increases the problem complexity and the possibility of detection confusion among the markers. More efficient use of the information from the neighboring frames and incorporating speed constraints could alleviate this problem. Nevertheless, because three or four markers are usually used during treatment, the probability of detecting at least one marker is high, even with current RapidArc planning.

1. A method for real-time 3D tracking of anatomical position during radiation therapy, the method comprising:
a) acquiring MV image data using an MV treatment beam rotating around a patient during an arc radiotherapy treatment, wherein the MV image data comprise projection images of the MV treatment beam;
b) during the arc radiotherapy treatment, computationally combining the acquired MV image data and associated angular positions to estimate 3D positions in time of an anatomical feature of the patient; and
c) during the arc radiotherapy treatment, reconstructing tomosynthetic images from the projection images of the MV treatment beam.

2. The method of claim 1 wherein computationally combining the acquired image data comprises combining present image data and prior image data at earlier times.

3. The method of claim 1 further comprising determining a motion of the anatomical feature or implanted marker from the estimated 3D positions in time.

4. The method of claim 3 further comprising acquiring supplementary MV image data when the determined motion of the anatomical feature or implanted marker is less than a predetermined threshold or abnormality level.

5. The method of claim 1 further comprising during the arc radiotherapy treatment, acquiring supplementary image data from a secondary imaging system, and computationally combining the acquired supplementary image data with the acquired image data to improve an accuracy of the estimated 3D positions.

6. The method of claim 5 wherein the acquiring supplementary image data from the secondary imaging system is performed only when an estimated displacement of the anatomical feature exceeds a predetermined threshold displacement or abnormality level.

7. The method of claim 5 wherein the acquiring supplementary image data from the secondary imaging system is performed only when an estimated displacement of the anatomical feature exceeds a predetermined threshold displacement and an estimated movement speed of the anatomical feature exceeds a predetermined threshold speed or abnormality level.

8. The method of claim 5 wherein the secondary imaging system is an onboard kV imaging system.
